(19) United States
(12) Patent Application Publication
(10) Pub. No.: US 2009/0100560 A1
(43) Pub. Date: Apr. 23, 2009

(54) LAUNDERABLE TRITIUM HOOD

(76) Inventor: Kent D. Anderson, East Longmeadow, MA (US)

Correspondence Address: HOLLAND & BONZAGNI, P.C., 171 DWIGHT ROAD, SUITE 302, LONGMEADOW, MA, 01106-1700, US

(21) Appl. No.: 11/876,867

(22) Filed: Oct. 23, 2007

(51) Int. Cl. A62B 17/04; A42B 1/04; A41D 3/00

(52) U.S. Cl. 2/15; 2/202; 2/457

(57) ABSTRACT

Applicant has disclosed a “Launderable Tritium Hood” with a removable visor assembly that allows the visor (i.e., view plate) and the remainder of the hood to be cleaned separately, and by different methods, for their reuse. In the preferred embodiment, Applicant's invention comprises: a launderable tritium suit hood; a removable visor assembly with a visor removably attached to a channel assembly; and, a bead assembly attached to the hood's fabric by stitching, wherein the channel assembly, with its attached visor, can be press-fit onto the bead assembly and subsequently peeled off when desired. Applicant's invention can also be thought of as a method comprising: press fitting a removable visor assembly onto a bead affixed to a tritium suit hood to create a gas-tight seal between the visor assembly and hood; and lifting and peeling the visor assembly off the bead to remove the visor assembly from the hood.

### FIELD OF INVENTION

This invention relates to chemical protective suits for use in toxic environments. More specifically, it relates to a method and apparatus for laundering tritium suits.

### BACKGROUND OF THE INVENTION

The purpose of a chemical protective suit is to shield or isolate individuals from chemical, physical, and biological hazards that may be encountered during hazardous materials operations. Some chemical protective suit designs contain several components: coveralls, hoods, gloves, and boots. The hood is designed to be worn with coveralls, covering the head, face, arms, and torso.

Tritium suits protect a wearer against inhalation and skin exposure of H-3 in nuclear plants. Tritium is a radioactive isotope of hydrogen that contains one proton and two neutrons. It is a gas at standard temperature and pressure. Tritium is produced in nature and is also industrially produced as a by-product in nuclear reactors by neutron activation of lithium-6 as well as in heavy water-moderated reactors. Tritium is difficult to contain; rubber, plastic, and some kinds of steel are somewhat permeable. The emitted electrons from small amounts of tritium cause phosphors to glow; hence, tritium is used to make self-illuminating devices, such as watches and exit signs. Tritium is also used in nuclear weapons.

Some current tritium hoods are made with a TYVEK® QC fabric containing a thin, ten millimeter LEXAN® shield or visor which is affixed permanently to the fabric. The visor contains a ventilation opening which is closable by a flap, also made of the visor material. This flap is covered by an adhesive strip.

In the laundering of such tritium suit hoods, problems arise making the hoods unusable and unsafe. During the laundering process the ten millimeter LEXAN® visor could become distorted and possibly cracked. Also, the visor may dislodge from the fabric. Therefore, the tritium suit hoods are discarded rather than laundered and reused.

Accordingly, it is a principal object of the present invention to provide a removable visor for a tritium suit hood that allows the visor and the remainder of the hood to be cleaned separately, and by different methods, for their reuse.

It is a more specific object to provide a removable visor assembly, containing the removable visor, which will maintain a gas-tight seal when the visor assembly is attached to the hood.

It is another object to provide an easily replaceable visor, commensurate with the above-listed objects, for a tritium suit hood.

It is yet another object to provide a related method for removably attaching a visor onto a tritium suit hood.

### BRIEF DESCRIPTION OF THE DRAWINGS

The above and other objects will become more readily apparent when the following description is read in conjunction with the accompanying drawings, in which:

FIG. 1, labeled “Prior Art,” is a frontal view of a conventional tritium suit ensemble;

FIG. 2 shows the “Prior Art” hood of FIG. 1;

FIG. 3 is a frontal view of a “Launderable Tritium Hood” constructed in accordance with the present invention;

FIG. 4 is an enlarged view of the tritium suit hood, shown in FIG. 3, with its removable visor assembly partially pulled back;

FIG. 5 is a plan view of a removable visor depicted in FIGS. 3, 4, 6A and 6B;

FIG. 6A is an enlarged cross-sectional view, taken along sight line 6-6 of FIG. 4, showing the visor assembly attached to the hood;

FIG. 6B is an exploded view of FIG. 6A;

FIG. 7 is a perspective view of a strengthening clip depicted in FIGS. 3, 4, 6A and 6B; and

FIG. 8 is an enlarged view of an encircled portion in FIG. 4.

### SUMMARY OF THE INVENTION

Applicant has disclosed a “Launderable Tritium Hood” with a removable visor assembly that allows the visor and the remainder of the hood to be cleaned separately, and by different methods, for their reuse. In the preferred embodiment, Applicant's invention comprises: a tritium suit hood; a visor assembly; and connection means (e.g., a press-fit channel-and-bead system) for removably attaching the visor assembly onto the hood and later peeling off the visor assembly when desired. The preferred visor is press fit into the visor assembly for easy removal and replacement.

### DETAILED DESCRIPTION OF THE PREFERRED EMBODIMENTS

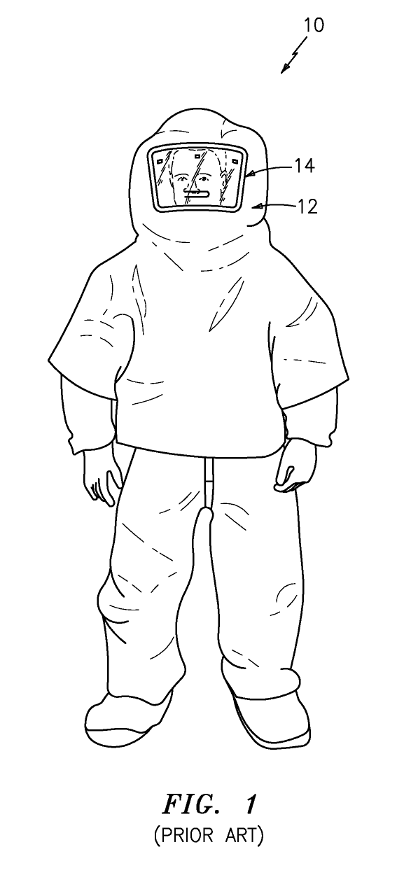

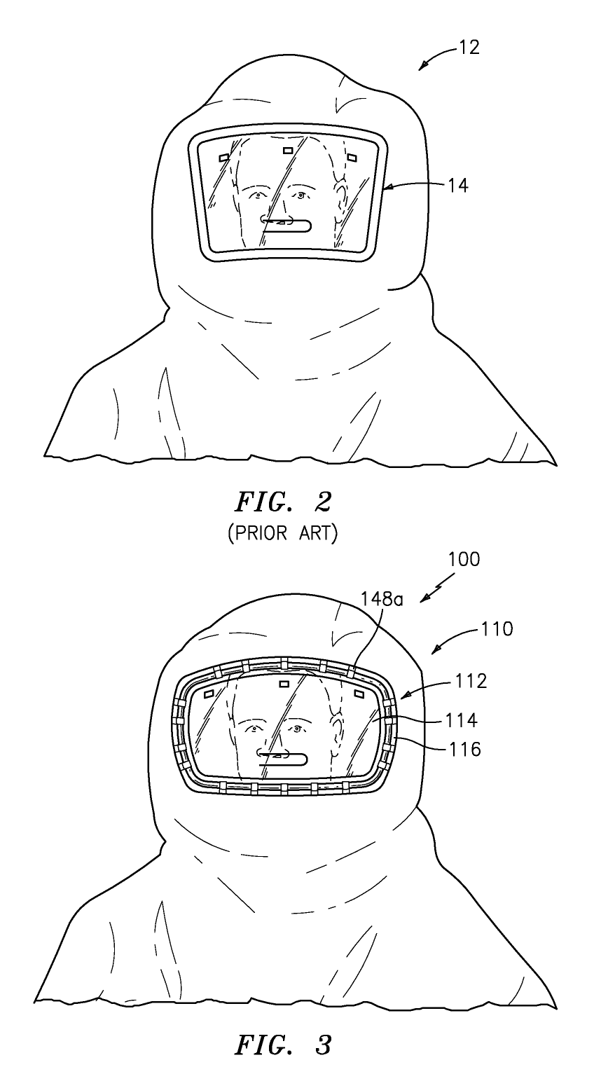

Applicant has invented a removable visor assembly for the hoods of chemical protective suits, such as tritium suit ensembles. The hood and visor assembly replace the hood (see FIG. 2) of the conventional suits, such as the tritium suit shown in FIG. 1.

FIGS. 1 and 2 depict a conventional tritium suit ensemble 10 (see FIG. 1). The removable hood 12 contains a visor 14 that is permanently affixed to the fabric as shown in FIG. 2.

FIGS. 3, 4, 5, 6A, 6B, 7 and 8 disclose the preferred embodiment 100 of the Applicant's invention: a launderable tritium suit hood 110; and, a removable visor assembly 112, wherein the visor assembly includes a view plate or visor 114 removably attached to a channel assembly 116; and, wherein the channel assembly 116, with its attached visor 114, can be press-fit onto a bead assembly 118 affixed to the hood 110 and subsequently peeled off when desired (e.g., for cleaning).

FIG. 3 shows Applicant's preferred visor assembly 112, with visor 114 and channel assembly 116, attached onto the hood 110 by a bead assembly 118. Applicant's preferred visor 114 is shaped like a rectangle which bulges primarily along its top and sides; however, any suitable shape (e.g., rhomboid) would do. The visor 114 is preferably made of LEXAN® material, approximately 20 to 30 millimeters thick. The added thickness makes the view plate 114 more durable and improves the user's vision.

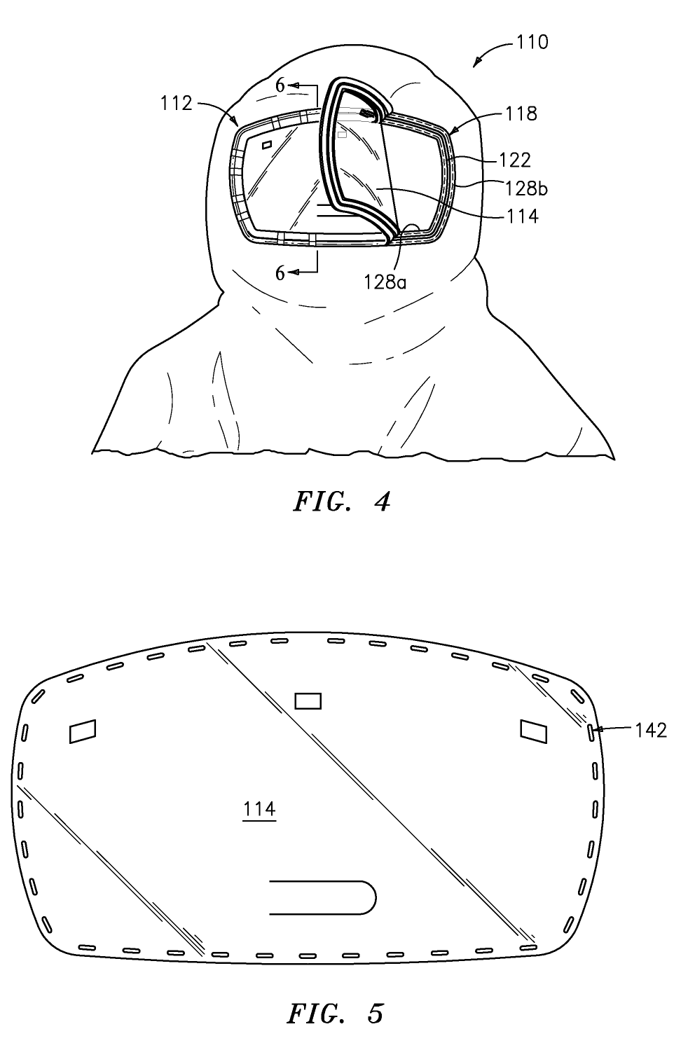

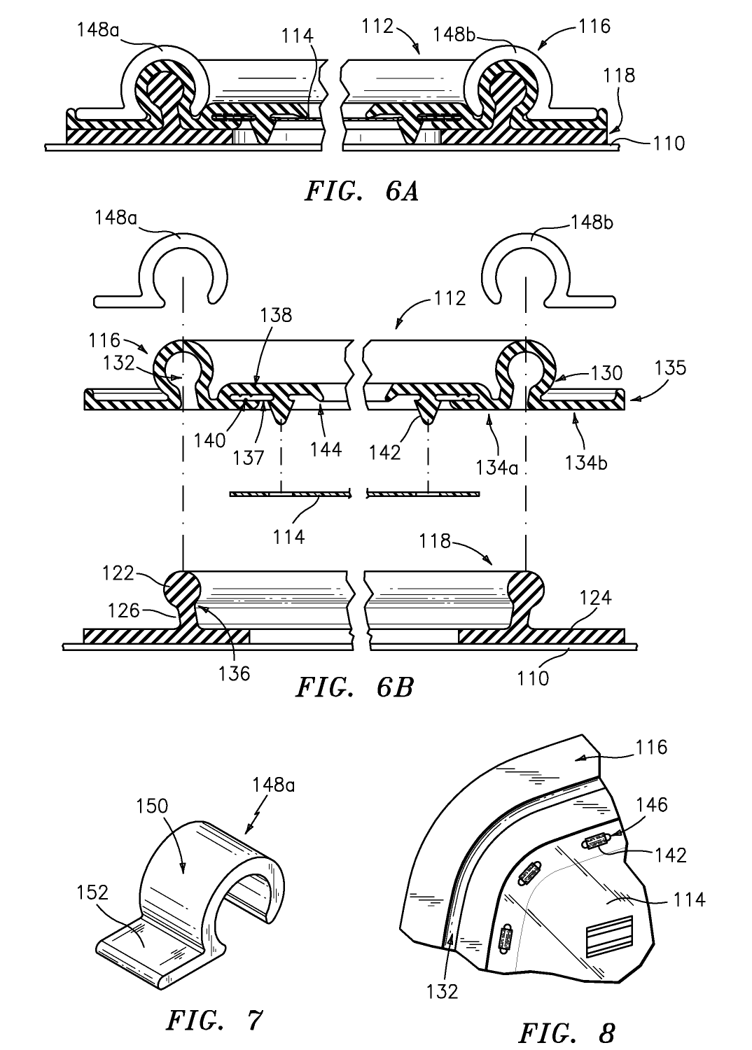

FIG. 4 shows the preferred visor assembly 112 partially pulled back, exposing the bead assembly 118. The perimeter of bead assembly 118 is also shaped like a bulging rectangle. Bead assembly 118 comprises the following integral parts, preferably made of neoprene rubber: a bead or bead strip 122 (see FIG. 6A) interconnected to a base 124 by a horizontally extending stem or stem strip 126. Two seams 128a, 128b, located on opposite “sides” of the stem strip 126, attach the base 124 to the fabric of the hood 110.

Bead 122 and stem 126 are canted slightly (see FIGS. 6A and 6B). They point upwardly and outwardly from the visor assembly 112.

FIG. 6A shows a cross-sectional view of the components of the preferred visor assembly 112 (i.e., the visor 114 and channel assembly 116) attached to the fabric of hood 110 by bead assembly 118. FIGS. 6B and 5 show the visor 114 separated from the neoprene channel assembly 116.

As best shown in FIG. 6B, the preferred channel assembly 116 comprises the following integral parts: an elongated channel housing 130, shaped like visor 114 (i.e., a bulging rectangle), having an internal channel or elongated keyway 132 configured to match the cross-sectional profiles of the bead 122 and stem 126; two generally flat base sections or wings 134a, 134b, shaped like visor 114, extending from and on opposites sides of housing 130, wherein base section 134b has an upturned end or lip 135; and a generally horizontal, visor connector 136 with a short bent-over end extending from the mid-width of base section 134a. Connector 136 and section 134a define a small space or gap 137 between them substantially equal to the thickness of visor plate 114. Small sharp teeth or barbs (e.g., at 138) extend outwardly from visor connector 136 into the space; and, small teeth or barbs (e.g., at 140) extends upwardly from base section 134a into the same space.

Visor connector 136 rims the entire channel assembly, inside the channel assembly's border. The connector 136 includes the following components: a short stem that extends upwardly from the mid-width of base section 134b, wherein the stem is elongated horizontally and follows around the entire channel assembly; discrete upside-down barbs, e.g., 142 (see FIGS. 7 and 6B), spaced along the connector 136, extending downwardly adjacent the connector's mid-point; and a down-turned free end or flange 144.

The barbs, e.g., 142, are inserted into and through corresponding spaced-apart slots, e.g., 146 (see FIGS. 7 and 6B) in the visor 114 to removably contact the visor 114 to the channel assembly 116. For added support, a border of the visor between the visor's slots and perimeter is slipped into the space 137, whereupon the teeth extending downwardly from visor connector 136 (e.g., at 138) and upwardly from section 134a (e.g., at 140), as well as the downturned flange 144, press against the visor (see FIG. 6A). The flange, teeth and small space create a tight press-fit which acts as a gas-tight seal. Glue can be added to create a permanent seal if a user does not want the visor to be removable for separate cleaning.

FIGS. 4, 6A and 6B illustrate the preferred visor assembly 112 attached to the hood 110. The attachment of the removable visor assembly 112 is somewhat similar to a TUPPERWARE® top attachment onto its container. When attaching the visor assembly 112, the elongated channel 130 of channel assembly 116 is pressed onto the bead strip 122 and stem strip 126, along the entire strips. This creates another gas-tight seal, this time between the visor assembly 112 and the hood 110. To release the visor assembly, the wing 134a is pulled outwardly and upwardly, at any location along the channel assembly 116, to break the seal. Then the visor assembly can be peeled easily from the hood, and the visor removed if desired.

In addition, several “snail-shell” clips (e.g., 148a, 148b), made of any suitable hard plastic, are strategically placed onto the channel assembly 116 at various locations for stability. More are located at the turns of the oval assembly. Each clip (e.g., 148a) has the following integral components: a flat-walled, upside down “C” (e.g., 150) contoured to be clipped onto the channel housing 130; and a horizontal plate section (e.g., 152), extending from the “C”, designed to be press fit atop wing 134b between the “C” and the base section's upturned lip 135.

Applicant's hood 110 is designed to be used at nuclear facilities. After being worn, the hood 110 is decontaminated at an offsite laundry (not shown). Prior hoods 12 (see FIGS. 1 and 2), with their permanently affixed visors 14, had to be thrown away. Otherwise, the visors would crack or physically distort during laundering. The preferred embodiment, with its removable visor assembly 112, allows the hood 110 and visor 114 to be washed and decontaminated separately, using different means. The hood 110 can be washed more vigorously than the visor assembly 112, with no damage caused to the visor 114. Then they can be rejoined for subsequent use.

The ability to launder the hood and visor separately makes it economically feasible to build a hood using a thicker view plate, since it will not be thrown away.

Applicant's visor assembly is interchangeable. If a visor becomes damaged, it can be easily replaced.

In its simplistic form, Applicant's invention can be thought of as: a launderable chemical suit hood (e.g., a tritium suit hood 110); a visor (e.g., 114); and connection means (e.g., channel assembly 116, bead assembly 118) for attaching the visor onto the hood and later peeling off the visor when desired (e.g., for cleaning). The connection means can be thought of as either a channel-and-bead system or a channel and bead.

Applicant's invention can also be thought of as a method of attaching a visor assembly onto a tritium suit hood and later removing the visor assembly and, if desired, subsequently removing the visor. The preferred overall method comprises: press fitting a visor assembly onto a bead affixed to the hood to create a gas-tight seal between the visor assembly and hood; and lifting and peeling the visor assembly off the bead to remove the visor assembly from the hood. The method further includes: press fitting the visor into the visor assembly, prior to press fitting the visor assembly onto the bead, for easy removal of the visor from the visor assembly. It also includes cleaning the visor and hood separately to remove any traces of tritium, by any standard means.

It should be understood by those skilled in the art that obvious structural modifications can be made to the Launderable Tritium Hood, beyond those noted above, without departing from the spirit of the invention. For example, while the preferred bead and channel assemblies are made of neoprene rubber, another elastomer may be suitable. Also, a plurality of strategically located single beads could be used instead of an integral bead strip. Accordingly, reference should be made primarily to the accompanying claims, rather than the foregoing description, to determine the scope of the invention.

I claim:

1. A launderable tritium suit hood comprising:
a. a tritium suit hood;
b. a visor assembly containing a visor; and
c. connection means for press-fitting the visor assembly onto the hood and for later peeling off the visor assembly when desired, wherein the connection means comprises a channel and a bead.

2. A launderable tritium suit hood comprising:
a. a tritium suit hood;
b. a visor assembly containing a visor; and
c. connection means for removably press-fitting the visor assembly onto the hood and for later peeling off the visor assembly when desired, wherein the connection means comprises:
i. a channel assembly affixed to the visor assembly;
ii. a bead assembly affixed to the hood;
iii. whereby the channel assembly, with its attached visor assembly, can be press-fit onto the bead assembly and subsequently peeled off the bead assembly.

3. The hood of claim 2 wherein:
a. the bead assembly comprises:
i. a bead strip interconnected to a base by a stem strip;
ii. the base is affixed to the hood; and
b. the channel assembly comprises:
i. an elongated channel housing having an internal keyway which matches cross-sectional profiles of the bead strip and stem strip.

4. The hood of claim 3 wherein the visor is press fit into the visor assembly.

5. A method comprising the following sequential steps:
a. press fitting a visor assembly onto a bead affixed to a tritium suit hood to create a gas-tight seal between the visor assembly and hood; and
b. lifting and peeling the visor assembly off the bead to remove the visor assembly from the hood.

6. The method of claim 5 further comprising press fitting the visor into the visor assembly, prior to step “a”; and removing the visor from the visor assembly after step “b.”

7. In a protective chemical suit hood of the type having a suit body and a removable hood with a visor, the improvement comprising:
a. connection means for removably press-fitting the visor onto the hood and for later peeling off the visor when desired, wherein the connection means comprises:
i. a channel assembly affixed to the visor;
ii. a bead assembly affixed to the hood;
iii. whereby the channel assembly, with its attached visor, can be press-fit onto the bead assembly and subsequently peeled off the bead assembly.

8. The hood of claim 7 wherein:
a. the bead assembly comprises:
i. a bead strip interconnected to a base by a stem strip;
ii. the base is affixed to the hood; and
b. the channel assembly comprises:
i. an elongated channel housing having an internal keyway which matches cross-sectional profiles of the bead strip and stem strip.

9. A method comprising:
a. press-fitting a visor assembly onto a bead affixed to a chemical suit hood to create a gas-tight seal between the visor assembly and hood; and
b. lifting and peeling the visor assembly off the bead to remove the visor assembly from the hood.

10. The method of claim 9 further comprising press fitting the visor into the visor assembly, prior to step “a”; and removing the visor from the visor assembly after step “b.”
